(19) United States
(12) Patent Application Publication
(10) Pub. No.: US 2017/0332010 A1
(43) Pub. Date: Nov. 16, 2017

(54) VEHICLE CONTROL SYSTEM, VEHICLE CONTROL METHOD, AND VEHICLE CONTROL PROGRAM

(71) Applicant: HONDA MOTOR CO., LTD., Tokyo (JP)

(72) Inventors: Masahiko Asakura, Wako-shi (JP); Kunimichi Hatano, Wako-shi (JP); Naoto Sen, Wako-shi (JP); Masaaki Abe, Wako-shi (JP)

(73) Assignee: HONDA MOTOR CO., LTD., Tokyo (JP)

(21) Appl. No.: 15/592,396

(22) Filed: May 11, 2017

(30) Foreign Application Priority Data
May 12, 2016 (JP) 2016-096171

(51) Int. Cl. H04N 5/232; G06K 9/00; H04N 7/18; B60S 1/02; G05D 1/02; B60R 11/04; B60Q 1/14; B60S 1/08; B60K 37/02; B60R 11/00

(52) U.S. Cl. CPC H04N 5/23222; G05D 1/027; G06K 9/00798; H04N 7/183; B60S 1/026; G05D 1/0257; B60S 1/0833; G05D 1/0223; B60R 11/04; G05D 1/0248; B60Q 1/143; B60K 2350/1028; B60K 2350/106; B60K 2350/1072; B60K 2350/2052; B60Q 2300/312; B60Q 2300/314; B60R 2011/0026; B60R 2011/004; B60K 37/02; B60R 2300/107; B60R 2300/301; B60R 2300/105

(57) ABSTRACT

A vehicle control system includes a vehicle-mounted imaging section configured to image surroundings of a vehicle, a vehicle-mounted imaging assist section configured to assist so as to increase the clarity of an imaging region of the imaging section, a recognition section configured to recognize surrounding conditions of the vehicle based on an image captured by the imaging section, an automated driving controller configured to execute automated driving in which at least one out of speed control or steering control is controlled automatically based on the surrounding conditions of the vehicle recognized by the recognition section, and an assist controller configured to adjust an operation of the imaging assist section when the automated driving is being implemented by the automated driving controller.

### CROSS REFERENCES TO RELATED APPLICATIONS

The present application claims priority under 35 U.S.C. §119 to Japanese Patent Application No. 2016-036171, filed May 12, 2016, entitled “Vehicle Control System, Vehicle Control Method, and Vehicle Control Program.” The contents of this application are incorporated herein by reference in their entirety.

### TECHNICAL FIELD

The present disclosure relates to a vehicle control system, a vehicle control method, and a vehicle control program.

### BACKGROUND

Control devices are known that automatically control wipers, lights, and the like, these being devices for improving visibility for a vehicle occupant, according to changes in the surrounding environment of a vehicle.

Recently, research into technology for controlling a vehicle so as to travel automatically along a route to a destination (referred to hereafter as “automated driving”) has been advancing. In such technology, surrounding conditions of a vehicle are detected based on, for example, imaging results of an imaging section or detection results of various sensors, and the vehicle is controlled based on the detection results (see, for example, International Publication (WO) No. 2011-158347).

In the related technology, when automated driving is being performed, sometimes it becomes impossible to recognize surrounding conditions of the vehicle with precision.

### SUMMARY

The present disclosure describes a vehicle control system, a vehicle control method, and a vehicle control program capable of more precisely recognizing surrounding conditions of a vehicle during automated driving.

A first aspect of the disclosure describes a vehicle control system including: an imaging section configured to image surroundings of a vehicle; an imaging assist section configured to assist so as to increase the clarity of an image captured by the imaging section; a recognition section configured to recognize surrounding conditions of the vehicle based on an image captured by the imaging section; an automated driving controller configured to execute automated driving in which at least one out of speed control or steering control is controlled automatically based on the surrounding conditions of the vehicle recognized by the recognition section; and an assist controller configured to adjust an operation of the imaging assist section when the automated driving is being implemented by the automated driving controller.

In a second aspect of the disclosure, in the vehicle control system according to the first aspect, configuration may be made wherein when the automated driving is being implemented, the assist controller actuates the imaging assist section at a threshold value lower than a threshold value for actuating the imaging assist section when the automated driving is not being implemented.

In a third aspect of the disclosure, in the vehicle control system according to the second aspect, configuration may be made wherein: the imaging section images surroundings of the vehicle from within a cabin of the vehicle; the imaging assist section includes a wiper; and the vehicle control system further includes a rain amount sensor configured to detect a rain amount. When the automated driving is being implemented, the assist controller lowers a first threshold value that is a threshold value for a rain amount detected by the rain amount sensor and that is a reference for actuating the wiper to a lower threshold value than when the automated driving is not being implemented.

In a fourth aspect of the disclosure, in the vehicle control system, according to the second aspect or the third aspect, configuration may be made wherein: the imaging section images surroundings of the vehicle front within a cabin of the vehicle; the imaging assist section includes a wiper; and the vehicle control system further includes a rain amount sensor configured to detect a rain amount. When the automated driving is being implemented, the assist controller lowers a second threshold value that is a threshold value for a rain amount detected by the rain amount sensor and that is a reference for actuating the wiper at higher speed to a lower threshold value than when the automated driving is not being implemented.

In a fifth aspect of the disclosure, in the vehicle control system according to any one of the second aspect to the fourth aspect, configuration may be made wherein: the imaging assist section includes a front headlight; and the vehicle control system further includes a light level sensor configured to detect a brightness of surroundings of the vehicle. When the automated driving is being implemented, the assist controller lowers a third threshold value that is a threshold value for a light level detected by the light level sensor and that, is a reference for switching on the front headlight to a lower threshold value than when the automated driving is not being implemented.

In a sixth aspect of the disclosure, in the vehicle control system, according to any one of the second aspect to the fifth aspect, configuration may be made wherein: the imaging assist section includes a front headlight; the vehicle control system further includes a light level sensor configured to detect a brightness of surroundings of the vehicle; and when the automated driving is being implemented, the assist controller lowers a fourth threshold value that is a threshold value for a light level detected by the light level sensor and that is a reference for increasing the intensity of light shone by the front headlight to a lower threshold value than when the automated driving is not being implemented.

In a seventh aspect of the disclosure, in the vehicle control system according to any one of the first aspect to the sixth aspect, configuration may be made wherein: the imaging assist section includes a front headlight; and the vehicle control system further includes a light level sensor configured to detect a brightness of surroundings of the vehicle. When the automated driving is being implemented, the assist controller controls the front headlight such that a light shone by the front headlight becomes more intense than when the automated driving is not being implemented or such that a region illuminated by the front headlight is changed to further toward a front side than when the automated driving is not being implemented.

In an eighth aspect of the disclosure, in the vehicle control system according to any one of the second aspect to the seventh aspect, configuration may be made wherein: the imaging section images surroundings of the vehicle from within a cabin of the vehicle; the imaging assist section includes a defroster; and the vehicle control system further includes a temperature sensor configured to detect an internal-external temperature difference of the vehicle. When the automated driving is being implemented, the assist controller lowers a fifth threshold value that is a threshold value for the temperature difference detected by the temperature sensor and that is a reference for actuating the defroster to a lower threshold value than when the automated driving is not being implemented.

In a ninth aspect of the disclosure, in the vehicle control system according to any one of the second aspect to the eighth aspect, configuration may be made wherein: the imaging section images surroundings of the vehicle from within a cabin of the vehicle; the imaging assist section includes a defroster; and the vehicle control system further includes a temperature sensor configured to detect an internal-external temperature difference of the vehicle. When the automated driving is being implemented, the assist controller lowers a sixth threshold value that is a threshold value for the temperature difference detected by the temperature sensor and that is a reference for controlling control of the defroster at a larger control amount to a lower threshold value than when the automated driving is not being implemented.

In a tenth aspect of the disclosure, in the vehicle control system according to any one of the second aspect to the ninth aspect, configuration may be made wherein: the imaging section images surroundings of the vehicle and a front window from within a cabin of the vehicle; and the imaging assist section includes a defroster. When the automated driving is being implemented, the assist controller analyzes an image captured by the imaging section, and lowers a seventh threshold value that is a threshold value for a degree of fogging of the front window derived from results of the analysis and that is a reference for actuating the defroster to a lower threshold value than when the automated driving is not being implemented.

In an eleventh aspect of the disclosure, in the vehicle control system according to any one of the second aspect to the tenth aspect, configuration may be made wherein: the imaging section images surroundings of the vehicle and a front window from within a cabin of the vehicle; and the imaging assist section includes a defroster. When the automated driving is being implemented, the assist controller analyses an linage captured by the imaging section, and lowers an eighth threshold value that is a threshold value for a degree of fogging of the front window derived from analyzed results of the analysis and that is a reference for controlling control of the defroster at a larger control amount to a lower threshold value than when the automated driving is not being implemented.

A twelfth aspect of the disclosure describes a vehicle control method executed by an on-board computer, the method including: recognizing surrounding conditions of a vehicle based on an image captured by an imaging section mounted to the vehicle and configured to image surroundings of the vehicle; executing automated driving in which at least one out of speed control or steering control is controlled automatically based on the recognized surrounding conditions of the vehicle; and when the automated driving is being implemented, adjusting an operation of an imaging assist section to assist so as to increase the clarity of an image captured by the imaging section.

A thirteenth aspect of the disclosure describes a vehicle control program for causing an on-board computer to execute processing, the processing including: recognizing surrounding conditions of a vehicle based on an image captured by an imaging section mounted to the vehicle and configured to image surroundings of the vehicle; executing automated driving in which at least one out of speed control or steering control is controlled automatically based on the recognized surrounding conditions of the vehicle; and when the automated driving is being implemented, adjusting an operation of an imaging assist section to assist so as to increase the clarity of an imaged captured by the imaging section.

According to the first, fourth, sixth, seventh, ninth, and eleventh to thirteenth aspects of the disclosure, for example, the assist controller is capable of more precisely recognizing surrounding conditions of the vehicle during automated driving by adjusting operation of the imaging assist section when automated driving is being implemented by the automated driving controller.

According to the second, third, fifth, eighth, and tenth aspects of the disclosure, for example, the assist controller is capable of more precisely recognizing surrounding conditions of the vehicle by actuating the imaging assist section even with lower detection results from the respective sensors when the assist controller controls the imaging assist section automatically during automated driving.

### BRIEF DESCRIPTION OF THE DRAWINGS

The advantages of the disclosure will become apparent in the following description taken in conjunction with the following drawings.

FIG. 1 is a diagram illustrating configuration elements of a vehicle of one embodiment.

FIG. 2 is a functional configuration diagram focusing on a vehicle control system of one embodiment.

FIG. 3 is a configuration diagram of an HMI.

FIG. 4 is a diagram illustrating a state in which the position of a vehicle relative to a travel lane is recognized by a vehicle position recognition section.

FIG. 5 is a diagram illustrating an example of action plans generated for given segments.

FIG. 6 is a diagram illustrating an example of a configuration of a course generation section.

FIG. 7 is a diagram illustrating example candidates for a course generated by a course candidate generation section.

FIG. 8 is a diagram in which candidates for a course generated by a course candidate generation section are represented by course points.

FIG. 9 is a diagram illustrating a lane change target position.

FIG. 10 is a diagram illustrating a speed generation model in a case in which the speeds of three nearby vehicles are assumed to be constant.

FIG. 11 is a table illustrating an example of mode-specific operation permission information.

FIG. 12 is a flowchart illustrating an example of a flow of processing executed in a vehicle.

FIG. 13 is a diagram illustrating an example of a comparison between threshold values for manual driving and threshold values for automated driving for a wiper device.

FIG. 14 is a flowchart illustrating another example (1) of a flow of processing executed in a vehicle.

FIG. 15 is a diagram illustrating an example of a comparison between threshold values for manual driving and threshold values for automated driving for a front headlight device.

FIG. 16 is a flowchart illustrating another example (2) of a flow of processing executed in a vehicle.

FIG. 17 is a diagram illustrating an example of a comparison between threshold values for manual driving and threshold values for automated driving for a defroster device.

### DETAILED DESCRIPTION

Explanation follows regarding embodiments of a vehicle control system, a vehicle control method, and a vehicle control program of the present disclosure, with reference to the drawings.

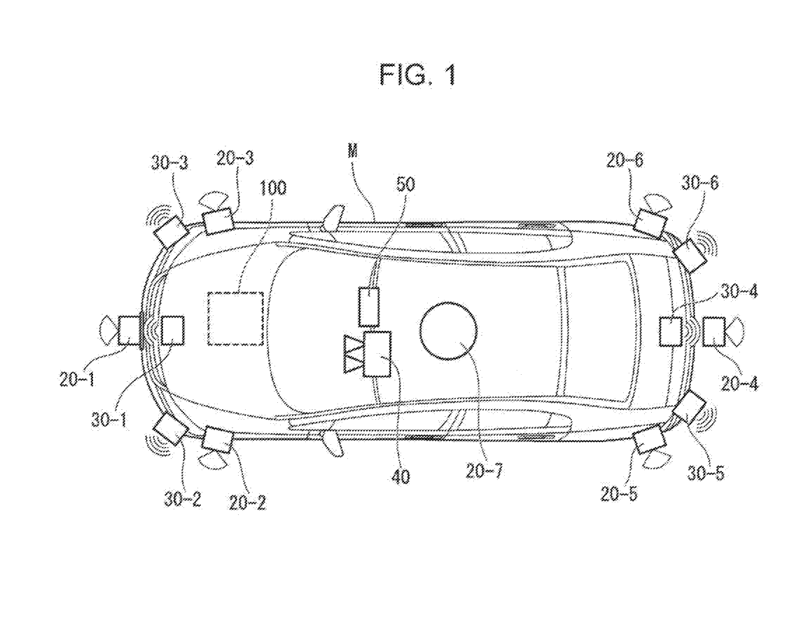

Explanation follows regarding an embodiment of a vehicle control system, a vehicle control method, and a vehicle control program of the present disclosure, with reference to the drawings. FIG. 1 is a diagram illustrating configuration elements of a vehicle (referred to as the vehicle M hereafter) installed with a vehicle control system 100 of the respective embodiments. The vehicle installed with the vehicle control system 100 is, for example, a two-wheeled, three-wheeled, or four-wheeled automobile, and this encompasses automobiles having an internal combustion engine such as a diesel engine or gasoline engine as a power source, electric automobiles having an electric motor as a power source, and hybrid automobiles having both an internal combustion engine and an electric motor. Electric automobiles are, for example, driven using electric power discharged from a battery such as a secondary cell, a hydrogen fuel cell, a metal fuel cell, or an alcohol fuel cell.

As illustrated in FIG. 1, sensors such as finders 20-1 to 20-7, radars 30-1 to 30-6, and a camera 40; a navigation device 50; and the vehicle control system 100 are installed to the vehicle M.

The finders 20-1 to 20-7 are, for example, LIDARs (Light Detection and Ranging, or Laser Imaging Detection and Ranging) that measure the scattering of emitted light and measure the distance to a target. For example, the finder 20-1 is attached to a front grille or the like, and the finder 20-2 and the finder 20-3 are attached to a side face of a vehicle body, a door mirror, a front headlight interior, the vicinity of a side lamp, or the like. The finder 20-4 is attached to a trunk lid or the like, the finder 20-5 and the finder 20-6 are attached to a side face of the vehicle body, a tail light interior, or the like. The finders 20-1 to 20-6 described above have detection regions of, for example, approximately 150° in a horizontal direction. The finder 20-7 is attached to a roof or the like. The finder 20-7 has a detection region of, for example, 360° in the horizontal direction.

The radar 30-1 and the radar 30-4 are, for example, long-range millimeter wave radars having a wider detection region in a depth direction than the other radars. The radars 30-2, 30-3, 30-5, 30-6 are intermediate-range millimeter wave radars having a narrower detection region in the depth direction than the radars 30-1 and 30-4.

Hereafter, the finders 20-1 to 20-7 are simply referred to as “finders 20” in cases in which no particular distinction is made, and the radars 30-1 to 30-6 are simply referred to as “radars 30” in cases in which no particular distinction is made. The radars 30, for example, detect objects using a frequency modulated continuous wave (FM-CW) method.

The camera 40 is, for example, a digital camera that employs a solid state imaging element such as a charge coupled device (CCD) or a complementary metal oxide semiconductor (CMOS) element. The camera 40 is attached to a front windshield upper portion, a back face of a rear-view mirror, or the like. The camera 40, for example, periodically and repeatedly images ahead of the vehicle M. The camera 40 may be a stereo camera that includes plural cameras. Moreover, the camera 40 may include a camera attached to the roof of the vehicle M.

Note that the configuration illustrated in FIG. 1 is merely an example; a portion of the configuration may be omitted, and other configuration may be further added.

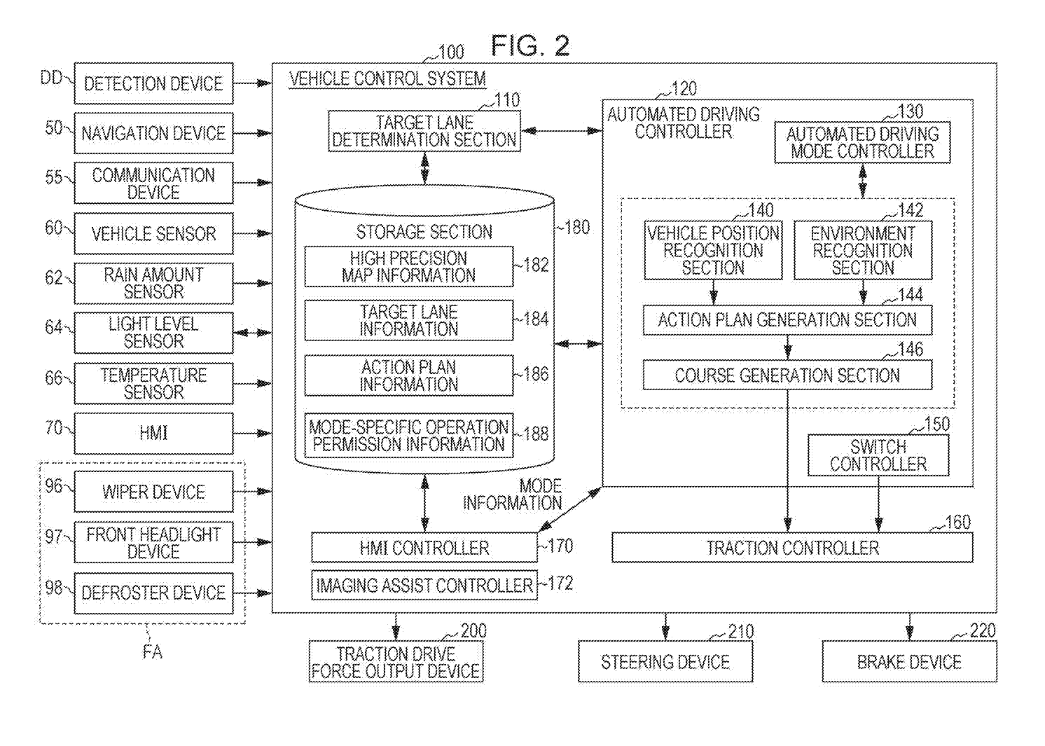

FIG. 2 is a functional configuration diagram focusing on the vehicle control system 100 according to the present embodiment. Detection devices DD that include the finders 20, the radars 30, the camera 40, and the like; the navigation device 50; a communication device 55; vehicle sensors 60; a rain amount sensor 62; a light level sensor 64; temperature sensors 66; a human machine interface (HMI) 70; a wiper device 96; a front headlight device 97; a defroster device 98; the vehicle control system 100; a traction drive force output device 200; a steering device 210; and a brake device 220 are installed in the vehicle M. These devices and apparatuses are connected to one another by a multiples communication line such as a controller area network (CAN) communication line, or by a serial communication line, a wireless communication network, or the like. Note that the vehicle control system within the scope of the claims does not indicate only the “vehicle control system 100” and may encompass configuration other than that of the vehicle control system 100 (such as the detection devices DD and the HMI 70). The wiper device S6, the front headlight device 97, and the defroster device 98 are an example of an “imaging assist section”. These elements are also referred to collectively as the imaging assist section FA hereafter.

The navigation device 50 includes a global navigation satellite system (GNSS) receiver, map information (a navigation map), a touch panel display device that functions as a user interface, a speaker, a microphone, and the like. The navigation device 50 identifies the position of the vehicle M using the GNSS receiver and derives a route from this position to a destination designated by a user. The route derived by the navigation device 50 is provided to a target lane determination section 110 of the vehicle control system 100. The position of the vehicle M may be identified or complemented by an inertial navigation system (INS) employing output, from the vehicle sensors 60. When the vehicle control system 100 is executing a manual driving mode, the navigation device 50 provides guidance along a route to the destination using audio and a navigation display. Note that configuration for identifying the position of the vehicle M may be provided independently from the navigation device 50. Moreover, the navigation device 50 may, for example, be implemented by functionality of a terminal device such as a smartphone or a tablet terminal possessed by the user. In such cases, information is exchanged between the terminal device and the vehicle control system 100 using wireless or wired communication.

The communication device 55, for example, performs wireless communication using a cellular network, a Wi-Fi network, Bluetooth (registered trademark), dedicated short range communication (DSRC), or the like.

The vehicle sensors 60 include, for example, a vehicle speed sensor that detects vehicle speed, an acceleration sensor that detects acceleration, a yaw rate sensor that detects angular velocity about a vertical axis, and a directional sensor that detects the heading of the vehicle M.

The rain amount sensor 62 is, for example, attached to a back face of a rear view mirror. The rain amount sensor 62 includes, for example, a light-emitting diode (light-emitting element) that projects light for raindrop detection toward a front window, a photodiode (light-receiving element) that receives light from the light-emitting diode that has been reflected back from the front window, and an estimation section configured by a processor such as a Central Processing Unit (CPU). The estimation section estimates a rainfall amount based on the amount of light received by the photodiode, and outputs estimation results to the vehicle control system 100. Note that the functionality of the estimation section may be provided to the vehicle control system 100.

The light level sensor 64 is, for example, provided to an upper face of an instrument panel. The light level sensor 64 is a sensor that detects the brightness of the surroundings of the vehicle M. The light level sensor 64 outputs detection results to the vehicle control system 100.

The temperature sensors 66 include an exterior air temperature sensor that detects the ambient temperature outside the vehicle M, and an interior temperature sensor that detects the temperature inside the vehicle M in the vicinity of the front window. The temperature sensors 66 output detection results to the vehicle control system 100.

The wiper device 96 includes a wiper blade (not illustrated in the drawings), a wiper arm (not illustrated in the drawings), a motor (not illustrated in the drawings), and a wiper controller (not illustrated in the drawings). The wiper blade is coupled to the motor through the wiper arm. Motive force of the motor driven under the control of the wiper controller is transmitted to the wiper blade through the wiper arm. The wiper blade thereby moves back-and-forth across the front window, for example, wiping away raindrops, snow, and other adhered material that have adhered to the front window. Note that wiper blades may also be provided for a rear window or a window glass 90.

The front headlight device 97 includes a front headlight (not illustrated in the drawings), and a front headlight controller (not illustrated in the drawings). The front headlight illuminates ahead of the vehicle M under the control of the front headlight controller. The front headlight controller controls the front headlight so as to adjust an illumination range in a height direction, to adjust an illumination range in a vehicle width direction, and to adjust the beam intensity. For example, the front headlight switches between what is referred to as a low beam and a high beam. Note that in addition to the front headlight, the vehicle M may be provided with lamps that shine light toward the rear and sides of the vehicle M.

The defroster device 98 includes an air outlet (not illustrated in the drawings), an air-conditioner unit (not illustrated in the drawings), and a defroster controller (not illustrated in the drawings). The air outlet of the defroster device 38 is provided at a vehicle body front end side of the instrument panel. The defroster controller controls the air-conditioner unit to blow air toward the front window from the air outlet. This alleviates or removes fogging (water droplets) on the front window.

Note that an air outlet of the defroster device 98 may be provided in the vicinity of a rear window or in the vicinity of the window glass 90 in addition to at the vehicle body front end side of the instrument panel. In such cases, air from the air-conditioner unit is blown from the air outlet toward the rear window or the window glass 90. Moreover, the defroster device 98 may include heating wires provided on the surface of or within the rear window or the window glass 90. The heating wires generate heat when electricity is supplied to the heating wires, thereby alleviating or removing fogging on the rear window or the window glass 90.

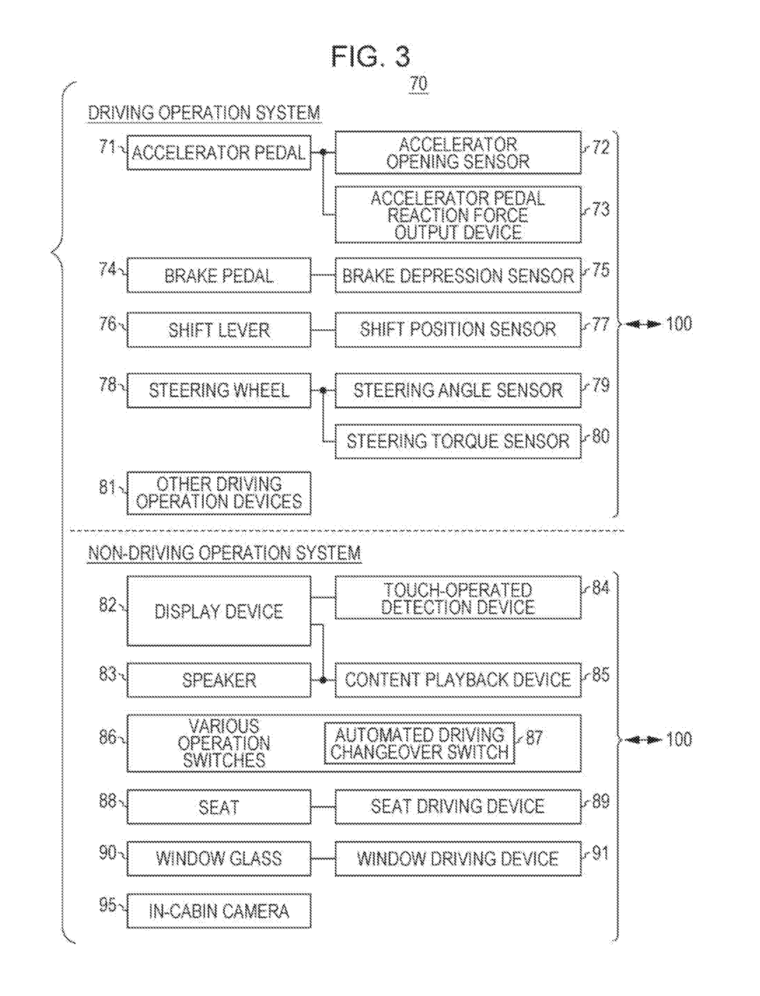

FIG. 3 is a configuration diagram of the HMI 70. The HMI 70 is provided with, for example, driving operation system configuration and non-driving operation system configuration. There is no clear boundary between the two, and driving operation system configuration may provide non-driving operation system functionality (or vice versa).

As configuration of the driving operation system, the HMI 70 includes, for example, an accelerator pedal 71, an accelerator opening sensor 72 and an accelerator pedal reaction force output device 73, a brake pedal 74 and a brake depression sensor (or a master pressure sensor or the like) 75, a shift lever 76 and a shift position sensor 77, a steering wheel 78, a steering angle sensor 79 and a steering torque sensor 80, and other driving operation devices 81.

The accelerator pedal 71 is an operation element for receiving acceleration instructions from a vehicle occupant (or deceleration instructions due to return-operation). The accelerator opening sensor 72 detects a depression amount of the accelerator pedal 71, and outputs an accelerator opening signal indicating the depression amount to the vehicle control system 100. Note that output may be made directly to the traction drive force output device 200, the steering device 210, or the brake device 220 instead of outputting to the vehicle control system 100. Similar applies for other configuration of the driving operation system explained below. The accelerator pedal reaction force output device 73, for example, outputs force (an operation reaction force) in the opposite direction to the operation direction of the accelerator pedal 71, according to instructions from the vehicle control system 100.

The brake pedal 74 is an operation element for receiving deceleration instructions from the vehicle occupant. The brake depression sensor 75 detects a depression amount of (alternatively, the pressing force on) the brake pedal 74 and outputs a brake signal indicating the detection result to the vehicle control system 100.

The shift lever 76 is an operation element for receiving shift level change instructions from the vehicle occupant. The shift position sensor 77 detects the shift level instructed by the vehicle occupant and outputs a shift position signal indicating the detection result to the vehicle control system 100.

The steering wheel 78 is an operation element for receiving turning instructions from the vehicle occupant. The steering angle sensor 79 detects the steering angle of the steering wheel 78 and outputs a steering angle signal indicating the detection result to the vehicle control system 100. The steering torque sensor 80 detects the torque placed on the steering wheel 78 and outputs a steering torque signal indicating the detection result to the vehicle control system 100.

The other driving operation devices 81 are, for example, a joystick, a button, a dial switch, a graphical user interface (GUI) switch, and the like. The other driving operation devices 81 receive acceleration instructions, deceleration instructions, turning instructions, and the like and output the instructions to the vehicle control system 100.

As configuration of the non-driving, operation system, the HMI 70 includes, for example, a display device 82, a speaker 83, a touch-operated detection device 84 and a content playback device 85, various operation switches 86, a seat 88 and a seat driving device 89, the window glass 90 and a window driving device 91, and an in-cabin camera 95.

The display device 82 is, for example, a liquid crystal display (LCD), an organic electroluminescent (EL) display device, or the like attached to a respective section of an instrument panel, at a freely selected location facing the front passenger seat or rear seat, or the like. Moreover, the display device 82 may be a head-up display (HUD) that projects an image onto the front windshield or another window. The speaker 83 outputs audio. In cases in which the display device 82 is a touch panel, the touch-operated detection device 84 detects a contact position (touch position) on a display screen of the display device 82, and outputs the contact position to the vehicle control system 100. Note that the touch-operated detection device 84 may be omitted in cases in which the display device 82 is not a touch panel.

The content playback device 85 includes, for example, a digital versatile disc (DVD) playback device, a compact disc (CD) playback device, a television receiver, various guidance image generation devices, and the like. Some or all out of the display device 82, the speaker 83, the touch-operated detection device 84, and the content playback device 85 may be configured so as to be shared with the navigation device 50.

The various operation switches 86 are disposed at freely selected locations inside the vehicle cabin. The various operation switches 86 include an automated driving changeover switch 87 for instructing automated driving to start (or to start in the future) or stop. The automated driving changeover switch 87 may be a graphical user interface (GUI) switch or a mechanical switch. Moreover, the various operation switches 86 may include switches for driving the seat driving device 89, window driving device 91, or the like.

The seat 88 is a seat, in which the vehicle occupant sits. The seat, driving device 89 is capable of driving the reclining angle, front-rear direction position, yaw angle, and the like of the seat 88. The window glass 90 is, for example, provided to each door. The window driving device 91 drives opening and closing of the window glass 90.

The in-cabin camera 95 is a digital camera that employs a solid state imaging element such as a CCD or a CMOS element. The in-cabin camera 95 is attached to a position from which at least the head of the vehicle occupant, performing driving operation can be imaged, such as at the rear-view mirror, steering wheel boss section, or instrument panel. The in-cabin camera 95, for example, images the vehicle occupant periodically and repeatedly.

Prior to explaining the vehicle control system 100, explanation follows regarding the traction drive force output device 200, the steering device 210, and the brake device 220.

The traction drive force output device 200 outputs traction drive force (torque) for causing the vehicle to travel to drive wheels. In cases in which the vehicle M is an automobile that has an internal combustion engine as the power source, the traction drive force output device 200 includes, for example, an engine, a transmission, and an engine electronic control unit (ECU) that controls the engine. In cases in which the vehicle M is an electric automobile that has an electric motor as the power source, the traction drive force output device 200 includes, for example, a traction motor and a motor ECU that controls the traction motor. In cases in which the vehicle M is a hybrid automobile, the traction drive force output device 200 includes, for example, an engine, a transmission, and an engine ECU; and a traction motor and a motor ECU. In cases in which the traction drive, force output device 200 includes only an engine, the engine ECO adjusts the engine throttle opening, the shift level, or the like, in accordance with information input from a traction controller 160, described later. In cases in which the traction drive force output device 200 includes only a traction motor, the motor ECU adjusts a duty ratio of a PWM signal applied to the traction motor, in accordance with information input from the traction controller 160. In cases in which the traction drive force output device 200 includes an engine and a traction motor, the engine ECO and the motor ECO cooperatively control traction drive force, in accordance with information input from the traction controller 160.

The steering device 210 includes, for example, a steering ECU and an electric motor. The electric motor, for example, exerts force in a rack-and-pinion mechanism to change the orientation of the steering wheel. The steering ECU drives the electric motor in accordance with information input from the vehicle control system 100, or input information regarding the steering angle or steering torque, and changes the orientation of the steering wheel.

The brake device 220 is, for example, an electric servo brake device including a brake caliper, a cylinder that transmits hydraulic pressure to the brake caliper, an electric motor that causes the cylinder to generate hydraulic pressure, and a brake controller. The brake controller of the electric servo brake device controls an electric motor in accordance with information input from the traction controller 160, such that braking torque is output to each wheel in accordance with the braking operation. The electric servo brake device may include a mechanism that transmits hydraulic pressure generated due to operation of the brake pedal to the cylinder via a master cylinder as a backup. Note that the brake device 220 is not limited to the electric servo brake device explained above and may be an electronically controlled hydraulic brake device. The electronically controlled hydraulic brake device controls an actuator in accordance with information input from the traction controller 160 and transmits hydraulic pressure of a master cylinder to the cylinder. The brake device 220 may also include a regenerative brake that uses a traction motor which may be included in the traction drive force output device 200.

### Vehicle Control System

Explanation follows regarding the vehicle control system 100. The vehicle control system 100 is, for example, implemented by one or more processors, or by hardware having equivalent functionality such as circuitry. The vehicle control system 100 may be configured by a combination of a processor such as a CPU, a storage device, and an ECU (electronic control unit) in which a communication interface is connected fey an internal bus, or a micro-processing unit (MPU) or the like.

Returning to FIG. 2, the vehicle control system 100 includes, for example, the target lane determination section 110, an automated driving controller 120, the traction controller 160, the HMI controller 170, an imaging assist controller 172, and the storage section 180. The automated driving controller 120 includes, for example, an automated driving mode controller 130, a vehicle position recognition section 140, an environment recognition section 142, an action plan generation section 144, a course generation section 146, and a switch controller 150. Some or all out of the target lane determination section 110, the respective sections of the automated driving controller 120, the traction controller 160, the HMI controller 170, and the imaging assist controller 172 are implemented by the processor executing a program (software). Moreover, of these, some or all may be implemented by hardware such as a large scale integration (LSI) or an application specific integrated circuit (ASIC), or may be implemented by a combination of software and hardware.

The storage section 180 stores information such as high precision map information 182, target lane information 184, action plan information 186, and mode-specific operation permission information 188. The storage section 180 is implemented by read only memory (ROM) or random access memory (RAM), a hard disk drive (HDD), flash memory, or the like. The program executed by the processor may be pre-stored in the storage section 180, or may be downloaded from an external device via an onboard internet setup or the like. Moreover, the program may be installed in the storage section 180 by loading a portable storage medium storing the program into a drive device, not illustrated in the drawings. Moreover, the vehicle control system 100 may be configured distributed across plural computer devices.

The target lane determination section 110 is, for example, implemented by an MPU. The target lane determination section 110 divides the route provided from the navigation device 50 into plural blocks (for example, divides the route every 100 m along the direction of progress of the vehicle), and references the high precision map information 182 to determine the target lane for each block. The target lane determination section 110, for example, determines which lane number from the left to travel in. In cases in which a junction point, a merge point, or the like is present in the route, the target lane determination section 110, for example, determines the target lanes so as to enable the vehicle M to travel along a sensible travel route for advancing beyond the junction. The target lanes determined by the target lane determination section 110 are stored in the storage section 180 as the target lane information 184.

The high precision map information 182 is map information with higher precision than the navigation map of the navigation device 50. The high precision map information 182 includes, for example, lane-center information, lane-boundary information, or the like. The high precision map information 182 may also include, for example, road information, traffic restriction information, address information (addresses, postal codes), facilities information, phone number information, and the like. The road information includes information such as information indicating whether the type of road is an expressway, a toll road, a national highway, or a prefectural road; the number of lanes in the road; the width of each lane; the gradient of the road; the position of the road (three dimensional coordinates including a longitude, a latitude, and an altitude); the curvature of the lanes; the position of lane merge and junction points; and signage provided on the road. The traffic restriction information includes information regarding lane closures due to road work, traffic accidents, congestion, and the like.

The automated driving mode controller 130 determines the automated driving mode to be implemented by the automated driving controller 100. The automated driving mode in the present embodiment includes the following modes. Note that the following modes are merely examples, and the number of modes of the automated driving may be freely determined.

### Mode A

Mode A is the mode in which the level of automated driving is highest. In cases in which Mode A is being implemented, all vehicle controls, such as complex merging control, are performed automatically, such that a vehicle occupant does not need to monitor the surroundings or state of the vehicle M.

### Mode B

Mode B is the mode having the next highest level of automated driving after Mode A. Although in principle all vehicle control is performed automatically in cases in which Mode B is implemented, the driving operation of the vehicle M may be entrusted to the vehicle occupant depending on the situation. The vehicle occupant therefore needs to monitor the surroundings and state of the vehicle M.

### Mode C

Mode C is the mode having the next highest level of automated driving after Mode B. In cases in which Mode C is implemented, the vehicle occupant needs to perform confirmation operations on the HMI 70 depending on the situation. In Mode C, for example, the vehicle occupant is notified of the timing for a lane change, and the lane change is made automatically in cases in which the vehicle occupant has performed an operation on the HMI 70 instructing the lane change. The vehicle occupant therefore needs to monitor the surroundings and state of the vehicle M.

The vehicle position recognition section 140 of the automated driving controller 120 recognizes the lane in which the vehicle M is traveling (the travel lane) and the position of the vehicle M relative to the travel lane, based on the high precision map information 182 stored in the storage section 180, and the information input from the finders 20, the radars 30, the camera 40, the navigation device 50, or the vehicle sensors 60.

The vehicle position recognition section 140, for example, recognizes the travel lane by comparing a pattern of road demarcation lines (for example, an array of solid lines and dashed lines) recognized in the high precision map information 182 against a road demarcation line pattern of the surroundings of the vehicle M recognized in the images imaged using the camera 40. In the recognition, the position of the vehicle M acquired from the navigation device 50 or the processing result by the INS may foe taken into account.

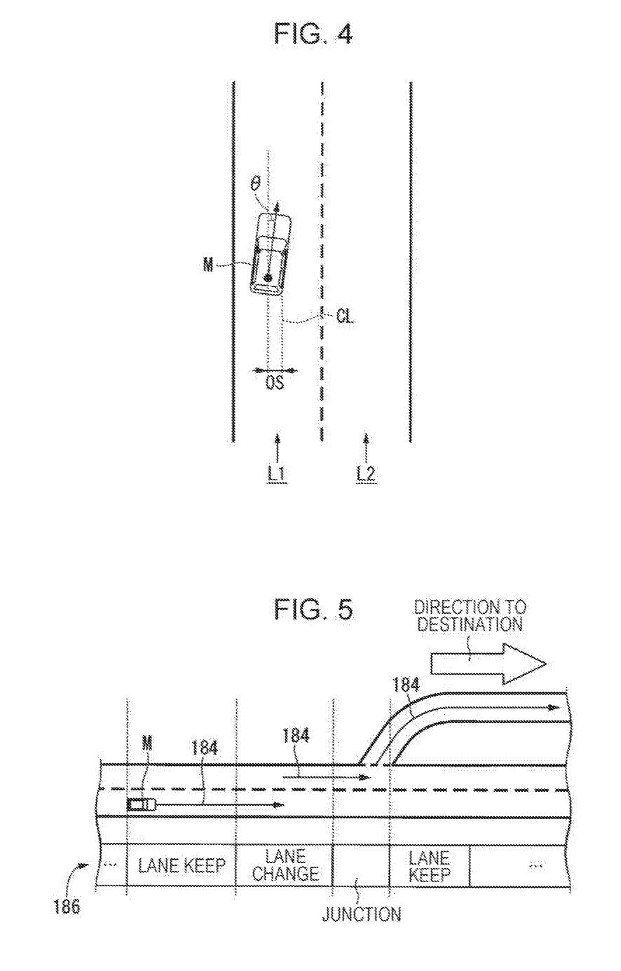

FIG. 4 is a diagram illustrating a state in which the relative position of the vehicle M with respect to a travel lane L1 is recognized by the vehicle position recognition section 140. As the relative position of the vehicle M with respect to the travel lane L1, the vehicle position recognition section 140 recognizes an offset OS between a reference point (for example, the center of mass) of the vehicle M and a travel lane center CL, and an angle θ formed between the direction of progress of the vehicle M and a line aligned with the travel lane center CL. Note that, alternatively, the vehicle position recognition section 140 may recognize the position of the reference point of the vehicle M or the like with respect to either of the side end portions of the lane L1 itself as the relative position of the vehicle M with respect to the travel lane. The relative position of the vehicle M recognized by the vehicle position recognition section 140 is provided to the target lane determination section 110.

The environment recognition section 142 recognizes the position, speed, and acceleration states of nearby vehicles based on the information input from the finders 20, the radars 30, the camera 40, and the like. Nearby vehicles are, for example, vehicles that are traveling in the surroundings of the vehicle M and that are traveling in the same direction as the vehicle M. The positions of the nearby vehicles may be presented as representative points such as centers of mass or corners of other vehicles, or may be represented as regions expressed by the outlines of the other vehicles. The “state” of a nearby vehicle may include whether or not the nearby vehicle is accelerating or changing lanes (or whether or not the nearby vehicle is attempting to change lanes), as ascertained based on the information of the various apparatuses described above. The environment recognition section 142 may also recognize the position of a guard rail, a utility pole, a parked vehicle, a pedestrian, and other objects in addition to the nearby vehicles.

The action plan generation section 144 sets a starting point of automated driving and/or a destination of automated driving. The starting point of automated driving may be the current position of the vehicle M, or may be a point set by operation to instruct automated driving. The action plan generation section 144 generates an action plan in the segments between the starting point and the destination of automated driving. Note that there is no limitation thereto, and the action plan generation section 144 may generate an action plan for freely selected segments.

The action plan is, for example, composed of plural events to be sequentially executed. The events include, for example: a deceleration event that causes the vehicle M to decelerate, an acceleration event that causes the vehicle M to accelerate, a lane-keep event that causes the vehicle M to travel without departing from the travel lane, a lane-change event that causes the travel lane to change, an overtake event that causes the vehicle M to overtake the vehicle in front, a junction event that causes a lane change to the desired lane at a junction point or causes the vehicle M to travel so as not to depart from the current travel lane, a merge event that causes the vehicle M to accelerate or decelerate in a merging lane for merging with a main lane and changes the travel lane, and a handover event that causes a transition from the manual driving mode to the automated driving mode at a starting point of automated driving or causes a transition from the automated driving mode to the manual driving mode at a point where automated driving is expected to end, The action plan generation section 144 sets a lane-change event, a junction event, or a merge event at places where the target lane determined by the target lane determination section 110 switches. Information indicating the action plan generated by the action plan generation section 144 is stored in the storage section 180 as the action plan information 186.

FIG. 5 is a diagram illustrating an example of action plans generated for given segments. As illustrated in this figure, the action plan generation section 144 generates the action plan needed for the vehicle M to travel in the target lane indicated by the target lane information 184. Note that the action plan generation section 144 may dynamically change the action plan irrespective of the target lane information 184, in accordance with changes to the conditions of the vehicle M. For example, in cases in which the speed of a nearby vehicle recognized by the environment recognition section 142 during vehicle travel exceeds a threshold value, or the movement direction of a nearby vehicle traveling in a lane adjacent to the vehicle-itself lane is toward the vehicle-itself lane direction, the action plan generation section 144 changes an event set in the driving segments that the vehicle M was expected to travel. For example, in cases in which events have been set such that a lane-change event is to be executed after a lane-keep event, when, during the lane-keep event, the recognition result of the environment recognition section 142 has determined that a vehicle is approaching from the rear in the lane change target lane at a speed at or above a threshold value, the action plan generation section 144 may change the event following the lane-keep event from a lane-change event to a deceleration event, a lane-keep event, or the like. As a result, the vehicle control system 100 can implement safe automated travel of the vehicle M even in cases in which a change occurs in the state of the environment.

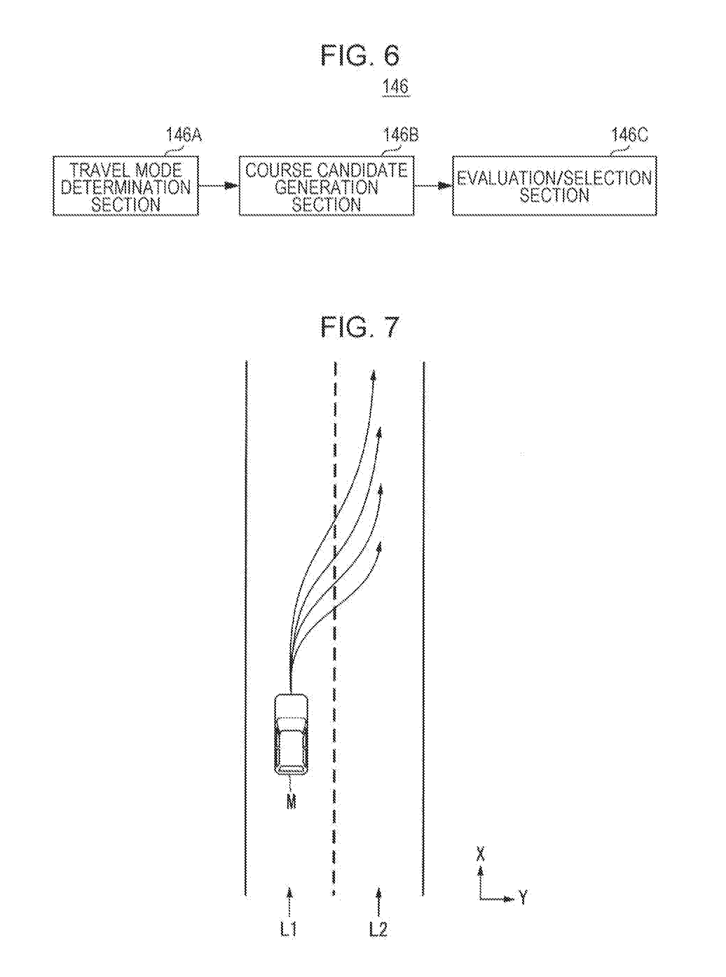

FIG. 6 is a diagram illustrating an example of the configuration of the course generation section 146. The course generation section 146 includes, for example, a travel mode determination section 146A, a course candidate generation section 146B, and an evaluation/selection section 146C.

When implementing a lane-keep event, the travel mode determination section 146A, for example, determines a travel mode from out of constant speed travel, following-travel, low speed following-travel, decelerating travel, curve travel, obstacle avoidance travel, or the like. In such cases, the travel mode determination section 146A determines that the travel mode is constant speed travel when no other vehicles are present ahead of the vehicle M. The travel mode determination section 146A determines that the travel mode is following-travel in cases such as when a vehicle in front is to be followed. The travel mode determination section 146A determines that, the travel mode is low speed following-travel in a congested situation or the like. The travel mode determination section 146A determines that the travel mode is decelerating travel in cases in which deceleration of a vehicle in front has been recognized by the environment recognition section 142, and in cases in which an event for, for example, stopping or parking is implemented. The travel mode determination section 146A determines that the travel mode is curve travel in cases in which the environment recognition section 142 has recognized that the vehicle M is approaching a curve in the road. The travel mode determination section 146A determines that the travel mode is obstacle avoidance travel in cases in which the environment recognition section 142 has recognized an obstacle in front of the vehicle M. Moreover, when carrying out lane-change events, overtake events, junction events, merge events, handover events, or the like, the travel mode determination section 146A determines the travel mode in accordance with each event.

The course candidate generation section 146B generates candidates for a course based on the travel mode determined by the travel mode determination section 146A. FIG. 7 is a diagram illustrating example candidates for a course generated by the course candidate generation section 146B. FIG. 7 illustrates candidates for a course generated when the vehicle M changes lanes from a lane L1 to a lane L2.

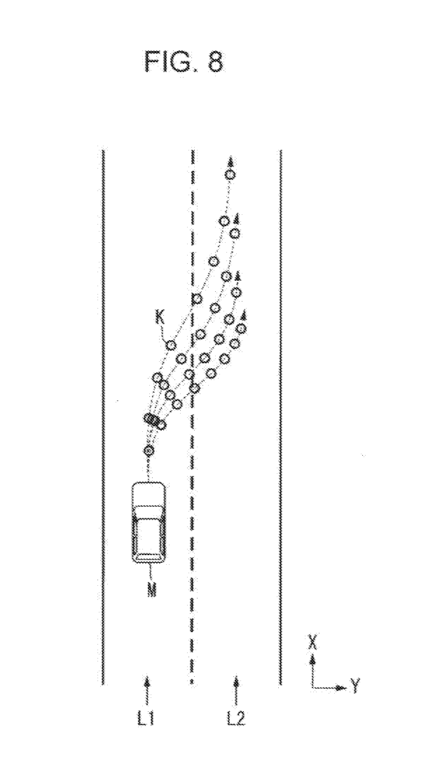

Courses such as illustrated in FIG. 7, for example, are determined by the course candidate generation section 146B as collections of target positions (course points K) where the reference position (for example, the center of mass or rear wheel axle center) of the vehicle M is to arrive at predetermined times in the future. FIG. 8 is a diagram illustrating candidates for a course generated by the course candidate generation section 146B, represented by course points K. The wider the separation between course points K, the faster the speed of the vehicle M, and the narrower the separation between course points K, the slower the speed of the vehicle M. Accordingly, the course candidate generation section 146B gradually widens the separations between the course points K when acceleration is desired, and gradually narrows the separations between the course points when deceleration is desired.

Thus, the course candidate generation section 146B needs to apply a target speed to each course point K since the course points K include a speed component. The target speed is determined in accordance with the travel mode determined by the travel mode determination section 146A.

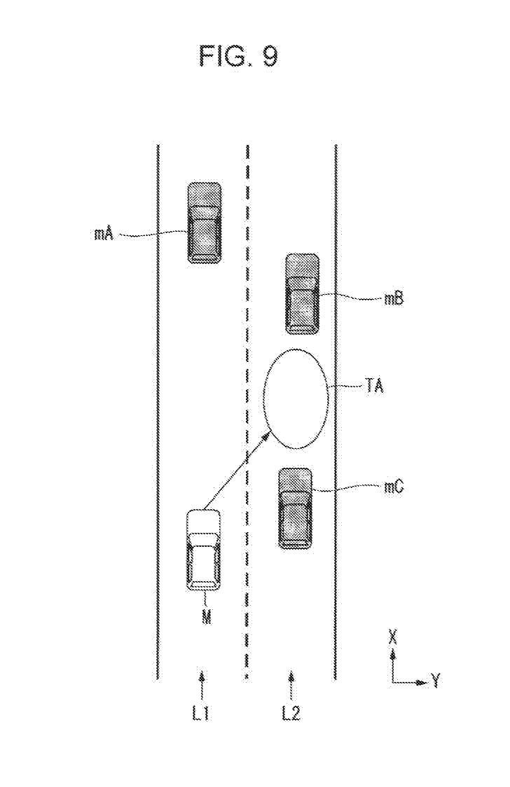

Explanation follows regarding a determination method for the target speed for performing a lane change (including at junctions). The course candidate generation section 146B first sets a lane change target position (or a merge target position). The lane change target position is set as a position relative to nearby vehicles, and determines “between which nearby vehicles to change lanes”. The course candidate generation section 146B observes three nearby vehicles as references for the lane change target position, and determines a target speed for performing the lane change. FIG. 9 is a diagram illustrating a lane change target position TA. In this figure, L1 represents the lane of the vehicle, and L2 represents an adjacent lane. Here, a vehicle in front mA is defined as a nearby vehicle traveling directly in front of the vehicle M in the same lane as the vehicle M, a forward reference vehicle mB is defined as a nearby vehicle traveling directly in front of the lane change target position TA, and a rear reference vehicle mC is defined as a nearby vehicle traveling directly behind the lane change target position TA. The vehicle M needs to accelerate or decelerate to move to beside the lane change target position TA, but must avoid tailgating the vehicle in front mA at this time. The course candidate generation section 146B therefore predicts the future state of the three nearby vehicles and determines a target speed that will not interfere with any of the nearby vehicles.

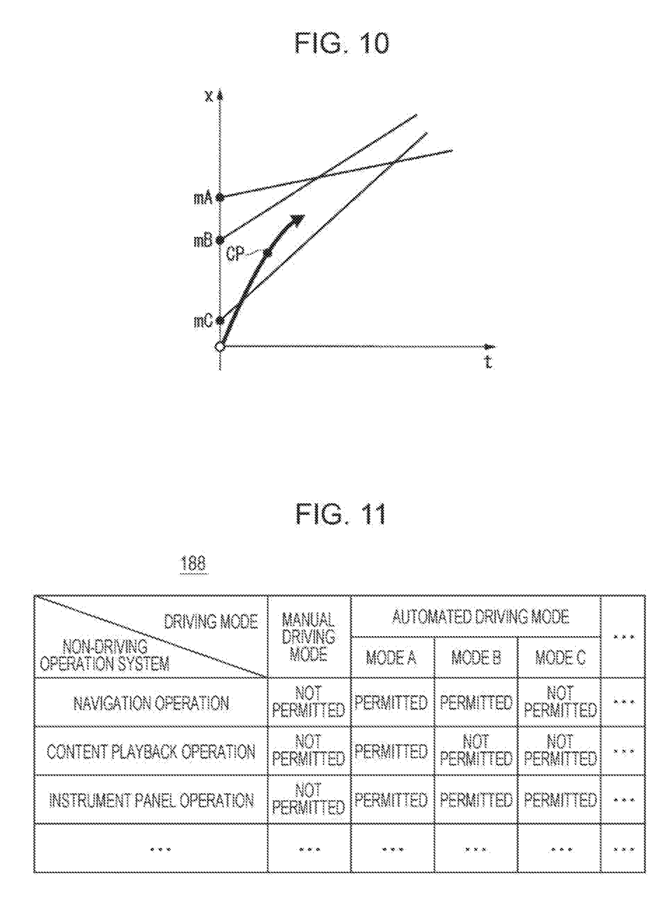

FIG. 10 is a diagram illustrating a speed generation model when the speed of the three nearby vehicles is assumed to be constant. In this figure, the straight lines extending from mA, mB, and mC each represent a displacement in the direction of progress when the nearby vehicles are assumed to be traveling at respective constant speeds. At a point CP where the lane change finishes, the vehicle M must be between the forward reference vehicle mB and the rear reference vehicle mC, and up to that point must be behind the vehicle in front mA. Under such restrictions, the course candidate generation section 146B derives plural time series patterns of target speeds up to when the lane change finishes. Then, the time series patterns of target speeds are applied to a model such as a spline curve to derive plural candidates for the course as illustrated in FIG. 8. Note that the movement pattern of the three nearby vehicles is not limited to that of constant speeds such as illustrated in FIG. 10, and may be predicted under the assumption of constant acceleration or constant jerk.

The evaluation/selection section 146C, evaluates, for example, the candidates for the course generated by the course candidate generation section 146B from the two viewpoints of plan achievability and safety, and selects a course to be output to the traction controller 160. From the viewpoint of plan achievability, a course is evaluated highly in cases in which, for example, the course closely follows a previously generated plan (for example, an action plan) and the total length of the course is short. For example, in cases in which a lane change to the right is desired, a course that temporarily changes lanes to the left and then returns is given a low evaluation. From the viewpoint of safety, for example, the further the distance between the vehicle M and an object (such as a nearby vehicle) and the smaller the amount of change in acceleration/deceleration, steering angle, or the like at each coarse point, the higher the evaluation.

The switch controller 150 switches between the automated driving mode and the manual driving mode based on a signal input from the automated driving changeover switch 87. The switch controller 150 also switches from the automated driving mode to the manual driving mode based on an operation on the configuration of the driving operation system of the HMI 70 instructing acceleration, deceleration, or steering. For example, the switch controller 150 switches from the automated driving mode to the manual driving mode (overrides) when a state in which an operation amount indicated by the signal input from the configuration of the driving operation system of the HMI 70 exceeds a threshold value has continued for a reference duration or longer. Note that after switching to the manual driving mode due to override, the switch controller 150 may return to the automated driving mode in cases in which operation on the configuration of the driving operation system of the HMI 70 has not been detected for a predetermined amount of time.

The traction controller 160 controls the traction drive force output device 200, the steering device 210, and the brake device 220 such that the vehicle M passes through the course generated by the course generation section 146 at expected timings.

When notified of information relating to the automated driving mode by the automated driving controller 120, the HMI controller 170 references the mode-specific operation permission information 183, and controls the HMI 70 according to the classification of the automated driving mode.

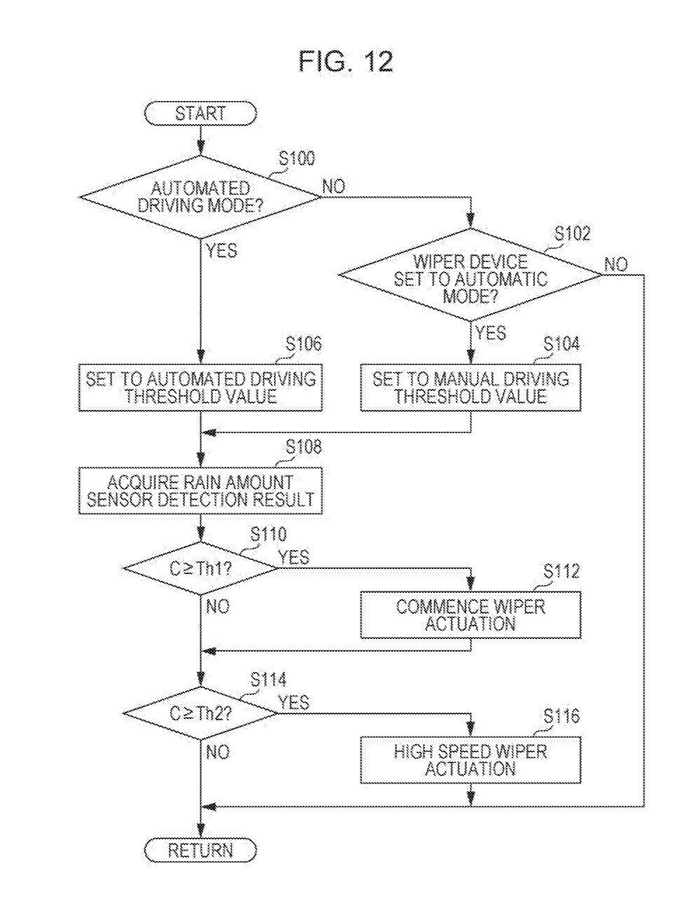

FIG. 11 is a table illustrating an example of the mode-specific operation permission information 188. The mode-specific operation permission information 188 illustrated in FIG. 11 includes “Manual driving mode” and “automated driving mode” as driving mode items. The mode-specific operation permission information 188 includes “Mode A”, “Mode B”, “Mode C”, and the like described above under “automated driving mode”. The mode-specific operation permission information 188 also includes “navigation operation”, which is an operation on the navigation device 50, “content playback operation”, which is an operation on the content playback device 85, “instrument panel operation”, which is an operation on the display device 82, and the like, as items of the non-driving operation system. In the example of the mode-specific operation permission information 188 illustrated in FIG. 11, permissions are set for operations by the vehicle occupant, on the non-driving operation system for each of the driving modes described above; however, the relevant interface devices are not limited thereto.

The HMI controller 170 determines the devices for which usage is permitted (part or all of the navigation device 50 and the HMI 70) and the devices for which usage is not permitted by referencing the mode-specific operation permission information 188 based on the mode information acquired from the automated driving controller 120. The HMI controller 170 also controls permissions for receiving operations on the HMI 70 or the navigation device 50 of the non-driving operation system from a vehicle occupant based on the determination result.

For example, when the driving mode executed by the vehicle control system 100 is the manual driving mode, a vehicle occupant operates the driving operation system of the HMI 70 (for example, the accelerator pedal 71, the brake pedal 74, the shift lever 76, the steering wheel 78, and the like). When the driving mode executed by the vehicle control system 100 is an automated driving mode such as Mode B or Mode C, the vehicle occupant has a responsibility to monitor the surroundings of the vehicle M. In such a case, in order to prevent activities (driver distractions) other than driving (for example, operating the HMI 70) from distracting the attention of the vehicle occupant, the HMI controller 170 performs control such that part or all of the non-driving operation system of the HMI 70 does not receive operations. At such times, in order to promote monitoring of the surroundings of the vehicle M, the HMI controller 170 may cause the presence of vehicles nearby the vehicle M that have been recognized by the environment, recognition section 142 and the state of these nearby vehicles to be displayed on the display device 82 using images or the like, and the HMI controller 170 may ensure confirmation operations are received by the HMI 70 in accordance with the situation the vehicle M is traveling in.

When the driving mode is Mode A of the automated driving modes, the HMI controller 170 relaxes driver distraction restrictions and performs control such that non-driving operation system that was not receiving operations can receive operations from the vehicle occupant. For example, the HMI controller 170 displays an image on the display device 82, outputs audio through the speaker 83, or plays back content from a DVD or the like on the content playback device 85. Note that in addition to content stored on a DVD or the like, the content played back by the content playback device 85 may include, for example, various content related to leisure and entertainment, such as television programming. The “content playback operation” illustrated in FIG. 11 may also mean a content operation related to such leisure and entertainment.

In cases in which automated driving is being implemented, the imaging assist controller 172 controls either part or all of the imaging assist section FA automatically. “Automatically” refers to starting operation of the imaging assist section FA, or automatically adjusting control amounts, according to the surrounding environment of the vehicle M. The imaging assist controller 172 automatically adjusts the speed, the time interval, and the like for the back-and-forth movement of the wiper device 96 based on the detection results of the rain amount sensor 62. The imaging assist controller 172 also automatically adjusts the light beam direction, region, beam intensity, and the like of the front headlight device 97 based on the detection results of the light level sensor 64. The imaging assist controller 172 also automatically adjusts the amount, temperature, speed, and the like of air blown by the defroster device 98 based on the detection results of the temperature sensors 66.

On the other hand, when automated driving is not being implemented, either part or all of the imaging assist section FA is automatically controlled when a vehicle occupant has performed a predetermined operation (set an automatic mode) using the various operation switches 86. When the automatic mode has not been set, the imaging assist section FA is controlled by manual operation by the vehicle occupant.

The imaging assist controller 172 adjusts operation of the imaging assist section FA when automated driving is being implemented by the automated driving controller 120. For example, when automated driving is being implemented, the imaging assist controller 172 enhances operation of the imaging assist section FA to a greater extent than when automated driving is not being implemented (specifically, in cases in which the automatic mode has been set). “Enhancing” refers to, for example, raising the sensitivity at which the imaging assist section FA actuates. In cases in which automated driving is being implemented, the imaging assist controller 172 controls the imaging assist section FA using lower threshold values (threshold values that trigger actuation more readily) than threshold values to actuate the imaging assist section FA automatically in cases in which automated driving is not being implemented (manual driving is being implemented) but the automatic mode has been set. The threshold values are threshold values by which controllers of the imaging assist section FA actuate the imaging assist section FA, or are threshold values used as a reference for adjusting control amounts, based on the detection results of the various sensors.

Accordingly, depending on the detection results detected by the various sensors, when automated driving is being implemented, sometimes the imaging assist section FA will actuate in a situation in which the imaging assist section FA would not actuate in a case in which automated driving was not being implemented but the automatic mode had been set. Moreover, when automated driving is being implemented, sometimes the control amount of the imaging assist section FA is increased in comparison to cases in which automated driving is not being implemented but the automatic mode has been set. As a result, the clarity of the imaging region of the camera 40 is increased. Explanation follows regarding specific processing.

### Wiper Control During Automated Driving

FIG. 12 is a flowchart illustrating an example of a flow of processing executed in the vehicle M. First, the imaging assist controller 172 determines whether or not the automated driving mode has been set by the automated driving mode controller 130 (step S100). In cases in which the automated driving mode has not been set, the imaging assist controller 172 determines whether or not the wiper device 96 has been set to the automatic mode (step S102). In cases in which the wiper device 96 has not been set to the automatic mode, the processing of a single routine of the flowchart is ended. In such cases, the wiper blade is actuated by manual operation by the vehicle occupant.

In cases in which the wiper device 96 has been set to the automatic mode, threshold values (sensitivities) for actuation of the wiper device are set to manual driving threshold values (step S104).

When the automated driving mode has been set at step S100, the imaging assist controller 172 sets the threshold values for actuation of the wiper device 96 to automated driving threshold values (step S106).

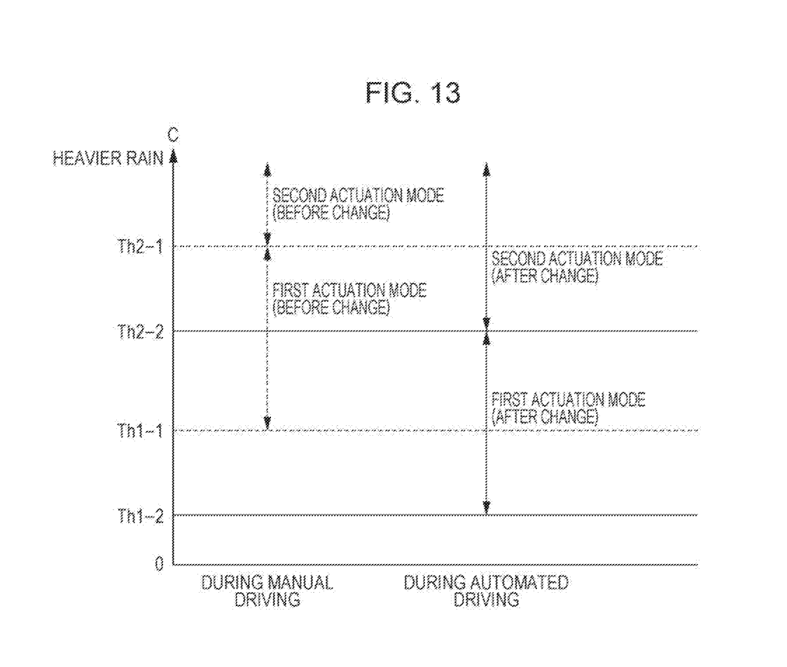

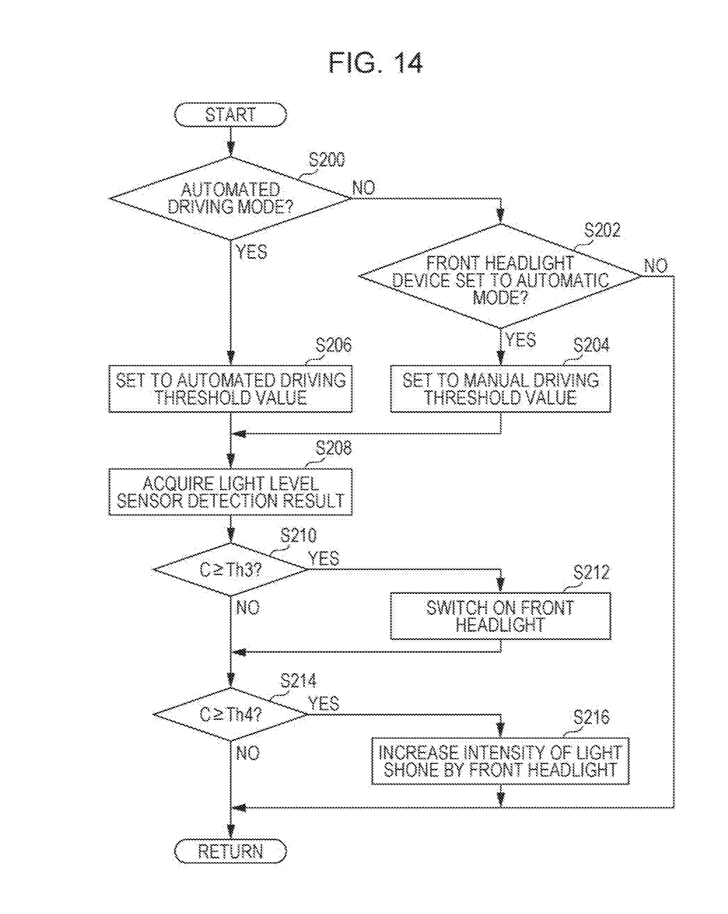

FIG. 13 is a diagram illustrating an example of a comparison between manual driving threshold values and automated driving threshold values for the wiper device 96. The vertical axis represents the rain amount detected by the rain amount sensor 62. The imaging assist controller 172 sets automated driving threshold values (Th1-2, Th2-2) that differ from the manual driving threshold values (Th1-1, Th2-1). An automated driving first threshold value Th1-2 is a lower value (a value that triggers actuation more readily) than a manual driving first threshold value Th1-1, and an automated driving second threshold value Th2-2 is a lower value than a manual driving second threshold value Th2-1. Moreover, the automated driving first threshold value Th1-2 is a lower value than the automated driving second threshold value Th2-2.

Due to setting the threshold values as described above, when a rain amount is between the automated driving first, threshold value Th1-2 and the manual driving first threshold value Th1-1, the wiper controller of the wiper device 96 actuates the wiper blade in a first actuation mode (described later) only in cases in which automated driving is being implemented.

Moreover, when a rain amount is between the manual driving first threshold value Th1-1 and the automated driving second threshold value Th2-2, the wiper controller actuates the wiper blade in the first actuation mode regardless of manual driving or automated driving. Moreover, when the rain amount is between the automated driving second threshold value Th2-2 and the manual driving second threshold value Th2-1, the wiper controller actuates the wiper blade in the first actuation mode during manual driving, and actuates the wiper blade in a second actuation mode during automated driving. Moreover, when the rain amount is the manual driving second threshold value Th2-1 or greater, the wiper controller actuates the wiper blade in the second actuation mode regardless of manual driving or automated driving.

The first actuation mode is, for example, an actuation mode appropriate for light rain or moderate rain around the vehicle M, and is, for example, a mode in which the wiper blade moves back-and-forth at a first speed. The second actuation mode is, for example, an actuation mode appropriate for heavy rain around the vehicle M, and is, for example, a mode in which the wiper blade moves back-and-forth at a second speed that is faster than the first speed.

By setting the threshold values as described above, the imaging assist controller 172 assists so as to increase the clarity of the imaging region imaged by the camera 40 to a greater extent when automated driving is being implemented than when automated driving is not being implemented but the automatic mode has been set.

In the following explanation, when setting the automated driving threshold values, a “first threshold value Th1” and a “second threshold value Th2” are respectively set to the “first threshold value Th1-2” and the “second threshold value Th2-2”. Mien setting the manual driving threshold values, a “first threshold value Th1” and a “second threshold value Th2” are respectively set to the “first threshold value Th1-1” and the “second threshold value Th2-1”.

Explanation now returns to FIG. 12. Next, the wiper controller acquires a detection result C of the rain amount sensor 62 (step S108), and determines whether or not the acquired detection result C is the first threshold value Th1 or greater (step S110). In cases in which the acquired detection result C is the first threshold value Th1 or greater, the wiper controller (not illustrated in the drawings) of the wiper device 96 commences actuation of the wiper blade (step S112).

In cases in which the acquired detection result C is not the first threshold, value Th1 or greater (is less than the first threshold value Th1), the wiper controller determines whether or not the acquired detection result C is the second threshold value Th2 or greater (step S114).

In cases in which the acquired detection result C is not the second threshold value Th2 or greater, the processing of a single routine of the flowchart is ended. In cases in which the acquired detection result C is the second threshold value Th2 or greater, the wiper controller actuates the wiper blade at higher speed (step S116). For example, when automated driving is being implemented, in cases in which the detection result C is the second threshold value Th2-2 or greater, the wiper blade is actuated in the second actuation mode, and in cases in which the detection result C is the first threshold value Th1-2 or greater but lower than the second threshold value Th2-2, the wiper blade is actuated in the first actuation mode. This thereby concludes the processing of a single routine of the flowchart.

As described above, when automated driving is being implemented, the imaging assist controller 172 enhances operation of the wiper device 96 so as to remove raindrops or the like adhering to the front window, thereby enabling the clarity of the imaging region of the camera 40 to be increased. As a result, the vehicle control system 100 is capable of recognizing the surrounding conditions of the vehicle more precisely during automated driving.

Front Headlight Device Control during Automated Driving

Explanation follows regarding control of the front headlight device 97 during automated driving in the present exemplary embodiment described above. FIG. 14 is a flowchart illustrating another example (1) of a flow of processing executed in the vehicle M. First, the imaging assist controller 172 determines whether or not the automated driving mode has been set by the automated driving mode controller 130 (step S200). In cases in which the automated driving mode has not been set, the imaging assist controller 172 determines whether or not the front headlight device 97 has been set to the automatic mode (step S202). In cases in which the front headlight device 97 has not been set to the automatic mode, the processing of a single routine of the flowchart is ended. In such cases, the front headlight is switched on by manual operation by the vehicle occupant.

In cases in which the front headlight device 97 has been set to the automatic mode, threshold values (sensitivities) for switching on the front headlight device 97 are set to manual driving threshold values (step S204).

When the automated driving mode has been set at step S200, the imaging assist controller 172 sets the threshold values for switching on the front headlight device 97 to automated driving threshold values (step S206).

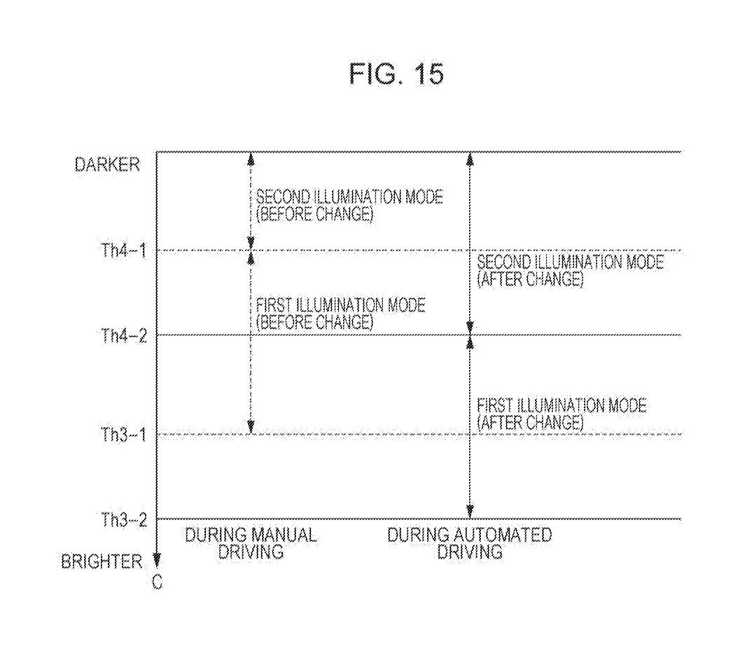

FIG. 15 is a diagram illustrating an example of a comparison between the manual driving threshold values and the automated driving threshold values for the front headlight device 97. The vertical axis indicates the light level (from darker to brighter) detected by the light level sensor 64. The imaging assist controller 172 sets automated driving threshold values (Th3-2, Th4-2) that differ from the manual driving threshold values (Th3-1, Th4-1). An automated driving third threshold value Th3-2 is a lower value than a manual driving third threshold value Th3-1, and an automated driving fourth threshold value Th4-2 is a lower value than a manual driving fourth threshold value Th4-1. Moreover, the automated driving third threshold value Th3-2 is a lower value than the automated driving fourth threshold value Th4-2.

Due to setting the threshold values as described above, when the brightness is between the manual driving third threshold value Th3-1 and the automated driving third threshold value Th3-2, the front headlight controller of the front headlight device 97 switches on the front headlight in a first illumination mode (described later) only in cases in which automated driving is being implemented.

Moreover, when the brightness is between the manual driving third threshold value Th3-1 and the automated driving fourth threshold value Th4-2, the front headlight controller switches on the front headlight in the first illumination mode regardless of manual driving or automated driving. Moreover, when the brightness is between the automated driving fourth threshold value Th4-2 and the manual driving fourth threshold value Th4-1, the front headlight controller switches on the front headlight in the first illumination mode during manual driving, and switches on the front headlight in a second illumination mode during automated driving. Moreover, when the brightness is the manual driving fourth threshold value Th4-1 or greater, the front headlight controller switches on the front headlight in the second illumination mode regardless of manual driving or automated driving.

The first illumination mode is, for example, an illumination mode appropriate for cases in which the surroundings of the vehicle M are slightly dim (for example a brightness level in a period leading up to dusk), and is, for example, a mode in which the front headlight device 97 illuminates the surroundings at a first intensity. The second illumination mode is, for example, an illumination mode appropriate for cases in which the surroundings of the vehicle M have become dark (for example a brightness level from dusk and on into the night), and is, for example, a mode in which the front headlight device 97 illuminates the surroundings at a second intensity that is stronger than the first intensity.

By setting the threshold values as described above, the imaging assist controller 172 assists so as to increase the clarity of the imaging region imaged by the camera 40 to a greater extent when automated driving is being implemented than when automated driving is not being implemented but the automatic mode has been set.

In the following explanation, when setting the automated driving threshold values, a “third threshold value Th3” and a “fourth threshold value Th4” are respectively set to the “third threshold value Th3-2” and the “fourth threshold value Th4-2”. When setting the manual driving threshold values, a “third threshold value Th3” and a “fourth threshold value Th4” are respectively set to the “third threshold value Th3-1” and the “fourth threshold value Th4-1”.

Explanation now returns to FIG. 14. Next, the front headlight controller acquires a detection result C of the light level sensor 64 (step S208), and determines whether or not the acquired detection result C is the third threshold value Th3 or greater (step S210). In cases in which the acquired detection result C is the third threshold value Th3 or greater, the front headlight controller switches on the front headlight (step S212).

In cases in which the acquired detection result C is not the third threshold, value Th3 or greater (is less than the third threshold value Th3), the front headlight controller determines whether or not the acquired detection result C is the fourth threshold value Th4 or greater (step S214).

In cases in which the acquired detection result C is not the fourth threshold value Th4 or greater, the processing of a single routine of the flowchart is ended. In cases in which the acquired detection result C is the fourth threshold value Th4 or greater, the front headlight controller increases the intensity of the light shone by the front headlight (step S216). For example, when automated driving is being implemented, in cases in which the detection result C is the fourth threshold value Th4-2 or greater, the front headlight is switched on in the second illumination mode, and in cases in which the detection result C is the is the third threshold value Th3-2 or greater but lower than the fourth threshold value Th4-2, the front headlight is switched on in the first illumination mode. This thereby concludes the processing of a single routine of the flowchart.

As described above, when automated driving is being implemented, the imaging assist controller 172 enhances operation of the front headlight device 97 so as to regulate to an appropriate light level around the vehicle M, thereby enabling the clarity of the imaging region of the camera 40 to be increased. As a result, the vehicle control system 100 is capable of recognizing the surrounding conditions of the vehicle more precisely during automated driving.

Note that the imaging assist controller 172 may also control the front headlight to change a region illuminated by the front headlight to further forward when automated driving is being implemented than when automated driving is not being implemented. For example, the imaging assist controller 172 changes the region illuminated by the front headlight toward the front side by controlling the front headlight such that an optical axis direction of the front headlight approaches a horizontal direction. The imaging assist controller 172 may approach the horizontal direction by changing from a low beam to a high beam, or, if finer control of the optical axis is possible, may control the optical axis to a predetermined direction between the low beam and the high beam. Note that the imaging assist controller 172 may also control the region illuminated by the front headlight based on detection results of the detection devices DD. For example, the imaging assist controller 172 may change the region illuminated by the front headlight to further forward as described above on the condition that it has been confirmed that no other vehicle (or person) is present ahead of the vehicle M.

### Defroster Device Control During Automated Driving

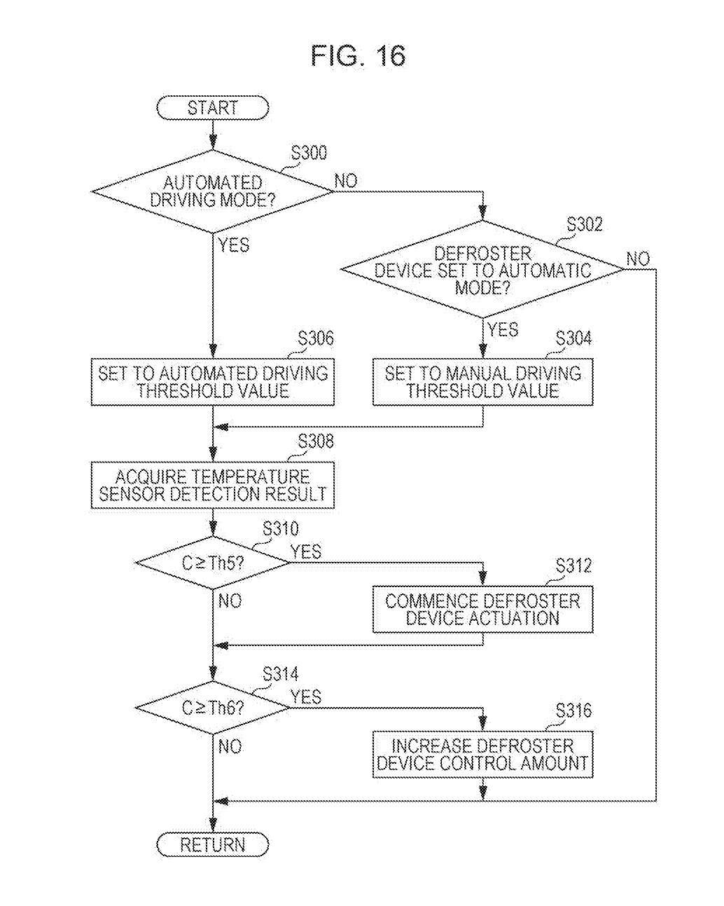

Explanation follows regarding control of the defroster device 98 during the automated driving described above in the present exemplary embodiment. FIG. 16 is a flowchart illustrating another example (2) of a flow of processing executed in the vehicle M. First, the imaging assist controller 172 determines whether or not the automated driving mode has been set by the automated driving mode controller 130 (step S300). In cases in which the automated driving mode has not been set, the imaging assist controller 172 determines whether or not the defroster device 98 has been set to the automatic mode (step S302). In cases in which the defroster device 98 has not been set to the automatic mode, the processing of a single routine of the flowchart is ended. In such cases, the defroster device 98 is actuated by manual operation by the vehicle occupant.

In cases in which the defroster device 98 has been set to the automatic mode, threshold values (sensitivities) for actuation of the defroster device 98 are set to manual driving threshold values (step S304).

When the automated driving mode has been set at step S300, the imaging assist controller 172 sets the threshold values for actuation of the defroster device 98 to automated driving threshold values (step S306).

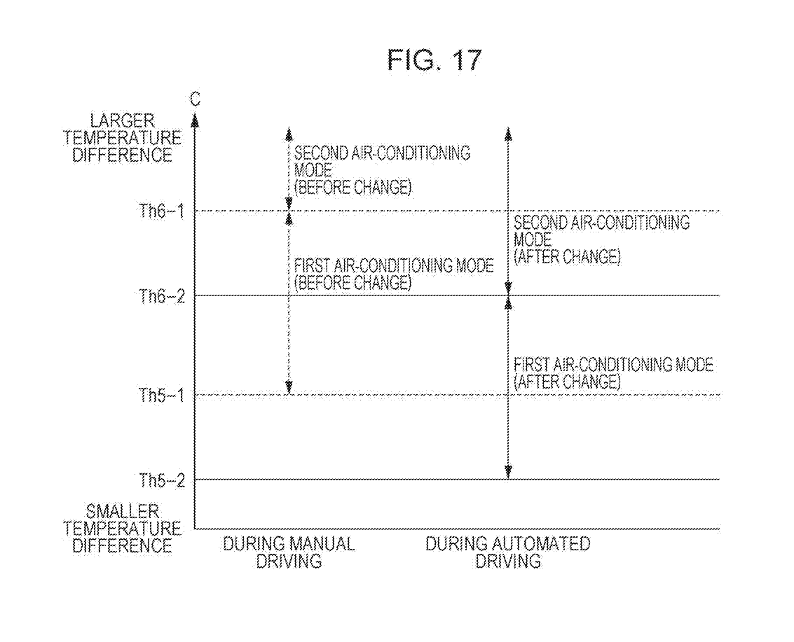

FIG. 17 is a diagram illustrating an example of a comparison between manual driving threshold values and automated driving threshold values for the defroster device 98. The vertical axis represents a temperature difference detected by the temperature sensors 66. The temperature difference is, for example, the temperature obtained by subtracting a temperature detected by the exterior air temperature sensor from a temperature detected by the interior temperature sensor. The imaging assist controller 172 computes the temperature difference from the detection results of the exterior air temperature sensor and the interior temperature sensor. The front window may fog up if the temperature difference reaches a predetermined temperature difference or greater. The greater the temperature difference becomes, the greater the extent of fogging of the front window can become.

The imaging assist controller 172 sets automated driving threshold values (Th5-2, Th6-2) that differ from manual driving threshold values (Th5-1, Th6-1). An automated driving fifth threshold value Th5-2 is a lower value than a manual driving fifth threshold value Th5-1, and an automated driving sixth threshold value Th6-2 is a lower value than a manual driving sixth threshold value Th6-1. Moreover, the automated driving fifth threshold value Th5-2 is a lower value than the automated driving sixth threshold value Th6-2.

Due to setting the threshold values as described above, when the temperature difference is between the manual driving fifth threshold value Th5-1 and the automated driving fifth threshold value Th5-2, the defroster controller of the defroster device 98 actuates the defroster device 98 in a first air-conditioning mode (described later) only in cases in which automated driving is being implemented.

Moreover, when the temperature difference is between the manual driving fifth threshold value Th5-1 and the automated driving sixth threshold value Th6-2, the defroster controller actuates the defroster device 98 in the first air-conditioning mode regardless of manual driving or automated driving. Moreover, when the temperature difference is between the automated driving sixth threshold value Th6-2 and the manual driving sixth threshold value Th6-1, the defroster controller actuates the defroster device 98 in the first air-conditioning mode during manual driving, and actuates the defroster device 98 in a second air-conditioning mode during automated driving. Moreover, when the temperature difference is the manual driving sixth threshold value Th6-1 or greater, the defroster controller actuates the defroster device 93 in the second air-conditioning mode regardless of manual driving or automated driving.

The first air-conditioning mode is, for example, an air-conditioning mode appropriate for a light or moderate degree of fogging of the front window, and is, for example, a mode in which the defroster device 98 blows air onto the front window at a first blow strength. The second air-conditioning mode is, for example, an air-conditioning mode appropriate for a heavy degree of fogging of the front window, and is, for example, a mode in which the defroster device 98 blows air onto the front window at a second blow strength that is higher than the first blow strength. Note that the second air-conditioning mode may also be a mode in which air is blown at a higher temperature than in the first air-conditioning mode.

By setting the threshold values as described above, the imaging assist controller 172 assists so as to increase the clarity of the imaging region imaged by the camera 40 to a greater extent when automated driving is being implemented than when automated driving is not being implemented but the automatic mode has been set.

In the following explanation, when setting the automated driving threshold values, a “fifth threshold value Th5” and a “sixth threshold value Th6” are respectively set to the “fifth threshold value Th5-2” and the “sixth threshold value Th6-2”. When setting the manual driving threshold values, a “fifth threshold value Th5” and a “sixth threshold value Th6” are respectively set to the “fifth threshold value Th5-1” and the “sixth threshold value Th6-1”.

Explanation now returns to FIG. 16. Next, the defroster controller acquires a detection result C of the temperature sensors 66 (step S308), and determines whether or not the acquired detection result C is the fifth threshold value Th5 or greater (step S310). In cases in which the acquired detection result C is the fifth first threshold value Th5 or greater, the defroster controller commences air blowing by the defroster device 98 (step S312).

In cases in which the acquired detection result C. is not the fifth threshold value Th5 or greater (is less than the fifth threshold value Th5), the defroster controller determines whether or not the acquired detection result C is the sixth threshold value Th6 or greater (step S314).

In cases in which the acquired detection result C is not the sixth threshold value Th6 or greater, the processing of a single routine of the flowchart is ended. In cases in which the acquired detection result C is the sixth threshold value Th6 or greater, the defroster controller increases a control amount (blow strength) with which air is blown from the air outlet (step S316). For example, when automated driving is feeing implemented, in cases in which the detection result C is the sixth threshold, value Th6-2 or greater, the defroster device 98 is actuated in the second air-conditioning mode, and in cases in which the detection result C is the fifth threshold value Th5-2 or greater but lower than the sixth threshold value Th6-2, the defroster device 98 is actuated in the first air-conditioning mode. This thereby concludes the processing of a single routine of the flowchart.

Note that in the present embodiment, explanation has been given in which the imaging assist controller 172 detects the extent of fogging on the front window based on the detection results of the temperature sensors 66. However, fogging of the front window may also be detected based on images captured by the camera 40. In such cases, the imaging assist controller 172 includes an image analysis section that analyzes images captured by the camera 40. The imaging assist controller 172 analyzes images captured by the camera 40, and determines fogging of the front window to have occurred based on a summed value or an average value of a brightness difference between respective images.

For example, when automated driving is being implemented, the imaging assist controller 172 analyzes images captured by the camera 40, and derives the extent of fogging on the front window from the analysis results. The imaging assist controller 172 employs a lower threshold value (seventh threshold value), this being a threshold value for the derived degree of fogging of the front window, and a reference for actuation of the defroster device 98, than a threshold value employed when automated driving is not being implemented. When automated driving is being implemented, the imaging assist controller 172 employs a lower threshold value (eighth threshold value), this being a threshold value for the derived degree of fogging of the front window, and a reference for controlling the defroster device 98 at a larger control amount, than a threshold value employed when automated driving is not being implemented.

Moreover, in the imaging assist controller 172, the degree of fogging of the front window may be detected based on the detection results of the rain amount sensor 62, or sensors having equivalent functions thereto. Moreover, in detection of fogging of the front window, images captured by a different camera to the camera 40 may be employed instead of employing images captured by the camera 40. Moreover, the image analysis section described above may be included in the vehicle control system 100 as a different functional section to the imaging assist controller 172.

As described above, when automated driving is being implemented, the imaging assist controller 172 enhances operation of the defroster device 98 so as to, for example, remove fogging that has occurred on the front window, thereby enabling the clarity of the imaging region of the camera 40 to be increased. As a result, the vehicle control system 100 is capable of recognizing the surrounding conditions of the vehicle more precisely during automated driving.

According to the embodiment described above, the vehicle control system 100 enhances operation of the imaging assist section FA when automated driving is being implemented. Accordingly, the vehicle control system 100 is capable of recognizing the surrounding conditions of the vehicle more precisely during automated driving.

The functions of the vehicle control system 100 of the respective embodiments described above are not mutually exclusive, and all or any two of the three may be implemented in combination.

Note that as a method to adjust the automatic mode so as to prioritize imaging by the camera 40 during automated driving, explanation has been given in which earlier actuation of the imaging assist section FA is achieved by lowering the threshold values. However, there is no limitation thereto, and threshold values may be raised according to the surrounding environment during automated driving. It is sufficient that suitable adjustment be made according to the surrounding environment. In such cases, the imaging assist controller 172 limits operation of the imaging assist section FA to a greater extent when automated, driving is being implemented than when automated driving is not being implemented. “Limiting” refers to, for example, reducing the sensitivity with which the imaging assist section FA is actuated. The imaging assist controller 172 controls the imaging assist section FA using higher threshold values (values that trigger actuation less readily) when automated driving is being implemented than threshold values for actuating the imaging assist section FA automatically when automated driving is not being implemented but the automatic mode has been set.

Explanation has been given above regarding embodiments for implementing the present disclosure. However, the present disclosure is not limited in any way by these embodiments, and various modifications or substitutions may be made in a range not departing from the spirit of the present disclosure. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

What is claimed is:

1. A vehicle control system comprising:
an imaging device configured to image surroundings of a vehicle;
an imaging assist section configured to assist in capturing an image by the imaging device so as to increase the clarity of the image captured by the imaging device;
a recognition controller configured to recognize surrounding conditions of the vehicle based on the image captured by the imaging device;
an automated driving controller configured to execute automated driving in which at least one out of speed control or steering control is controlled automatically based on the surrounding conditions of the vehicle recognized by the recognition controller; and
an assist controller configured to adjust an operation of the imaging assist section when the automated driving is being implemented by the automated driving controller.

2. The vehicle control system according to claim 1, wherein when the automated driving is being implemented, the assist controller actuates the imaging assist section by using a threshold value for actuating the imaging assist section which is lower than a threshold value for actuating the imaging assist section when the automated driving is not being implemented.

3. The vehicle control system according to claim 2, wherein:
the imaging device images the surroundings of the vehicle from the inside of a cabin of the vehicle;
the imaging assist section includes a wiper;
the vehicle control system further includes: a rain amount sensor configured to detect a rain amount; and
when the automated driving is being implemented, the assist controller lowers a first threshold value to a lower value which is lower than a value used when the automated driving is not being implemented, the first threshold value is a threshold value for the rain amount detected by the rain amount sensor and that is a reference for actuating the wiper.

4. The vehicle control system according to claim 3, wherein:
when the automated driving is being implemented, the assist controller lowers a second threshold value to a lower value which is lower than a value used when the automated driving is not being implemented, the second threshold value is a threshold value for the rain amount detected by the rain amount, sensor and that is a reference for actuating the wiper at higher speed than the speed corresponding to the first threshold value.

5. The vehicle control system according to claim 2, wherein:
the imaging assist section includes a front headlight;
the vehicle control system further includes a light level sensor configured to detect a brightness of surroundings of the vehicle; and
when the automated driving is being implemented, the assist controller lowers a third threshold value to a lower value which is lower than a value used when the automated driving is not being implemented, the third threshold value is a threshold value for a light level detected by the light level sensor and that is a reference for turning on the front headlight.

6. The vehicle control system according to claim 5, wherein:
when the automated driving is being implemented, the assist controller lowers a fourth threshold value to a lower value which is lower than a value used when the automated driving is not being implemented, the fourth threshold value is a threshold value for the light level detected by the light level sensor and that is a reference for increasing the intensity of light shone by the front headlight to a level higher than the intensity of light corresponding to the third threshold value.

7. The vehicle control system according to claim 1, wherein:
the imaging assist section includes a front headlight;
the vehicle control system further includes a light level sensor configured to detect a brightness of surroundings of the vehicle; and
when the automated driving is being implemented, the assist controller controls the front headlight such that a light shone by the front headlight becomes more intense than a light when the automated driving is not being implemented or such that a region illuminated by the front headlight is changed to further forward position than a position when the automated driving is not being implemented.

8. The vehicle control system according to claim 2, wherein:
the imaging device images the surroundings of the vehicle from the inside of a cabin of the vehicle;
the imaging assist section includes a defroster;
the vehicle control system further includes a temperature sensor configured to detect an internal-external temperature difference of the vehicle; and
when the automated driving is being implemented, the assist controller lowers a fifth threshold value to a lower value which is lower than a value used when the automated driving is not being implemented, the fifth threshold value is a threshold value for the temperature difference detected by the temperature sensor and that is a reference for actuating the defroster.

9. The vehicle control system according to claim 8, wherein:
when the automated driving is being implemented, the assist controller lowers a sixth threshold value to a lower value which is lower than a value used when the automated driving is not being implemented, the sixth threshold value is a threshold value for the temperature difference detected by the temperature sensor and that is a reference for controlling control of the defroster at a larger control amount than the control amount corresponding to the fifth threshold value.

10. The vehicle control system according to claim 2, wherein:
the imaging device images the surroundings of the vehicle, and a front window from the inside of a cabin of the vehicle;
the imaging assist section includes a defroster; and
when the automated driving is being implemented, the assist controller analyzes the image captured by the imaging device, and lowers a seventh threshold value to a lower value which is lower than a value used when the automated driving is not being implemented, the seventh threshold value is a threshold value for a degree of fogging of the front window derived from results of the analysis and that is a reference for actuating the defroster.

11. The vehicle control system according to claim 10, wherein:
when the automated driving is being implemented, the assist controller analyzes the image captured by the imaging device, and lowers an eighth threshold value to a lower value which is lower than a value used when the automated driving is not being implemented, the eighth threshold value is a threshold value for a degree of fogging of the front window derived from analyzed results of the analysis and that is a reference for controlling control of the defroster at a larger control amount larger than the control amount corresponding to the seventh threshold value.

12. A vehicle control method executed by an on-board computer, the method comprising:
recognizing surrounding conditions of a vehicle based on an image captured by an imaging device mounted to the vehicle and configured to image surroundings of the vehicle;
executing automated driving in which at least one out of speed control or steering control is controlled automatically based on the recognized surrounding conditions of the vehicle; and
when the automated driving is being implemented, adjusting an operation of an imaging assist section to assist in capturing the image by the imaging device so as to increase the clarity of the image captured by the imaging device.

13. A non-transitory computer readable medium storing a vehicle control program for causing an on-board computer to execute processing, the processing comprising:
recognizing surrounding conditions of a vehicle based on an image captured by an imaging device mounted to the vehicle and configured to image surroundings of the vehicle;
executing automated driving in which at least one out of speed control or steering control is controlled automatically based on the recognized surrounding conditions of the vehicle; and
when the automated driving is being implemented, adjusting an operation of an imaging assist section to assist in capturing the image by the imaging device so as to increase the clarity of the imaged captured by the imaging device.

14. The vehicle control system according to claim 1, wherein the assist controller is configured to adjust an operation of the imaging assist section when the automated driving is being implemented by the automated driving controller such that the imaging assist section operates differently from the operation of the imaging assist section when the automated driving is being implemented.

15. The vehicle control system according to claim 1, wherein the imaging assist section includes an imaging assist device configured to improve physical condition for capturing the image by the imaging device when the automated driving is being implemented.
